(19) United States
(12) Patent Application Publication
(10) Pub. No.: US 2011/0125599 A1
(43) Pub. Date: May 26, 2011

(54) Social License for Interactive Applications and Content

(76) Inventors: David Morin, San Francisco, CA (US); Joshua E. Elman, Mountain View, CA (US); Vishu Gupta, Atherton, CA (US); Blaise A. DiPersia, San Francisco, CA (US)

(21) Appl. No.: 12/623,004

(22) Filed: Nov. 20, 2009

(51) Int. Cl. G06Q 30/00; G06Q 10/00; G06Q 20/00; G06Q 50/00; G06Q 99/00; A63F 9/24

(52) U.S. Cl. 705/26.1; 705/30; 705/40; 705/310; 463/29; 726/28

(57) ABSTRACT

To encourage purchases and use, licenses to certain interactive applications and/or content are able to be given as gifts to others as part of a user purchasing a license for herself. In one implementation, each purchase of a license to an application includes the right to give a license to up to a predefined limit of other people. For example, the purchasing user buys a license for herself and the right to name a number of other people to also receive licenses to the same interactive application or content.

### BACKGROUND

The present invention relates generally to software applications that allow multiple users to interact, and more particularly to distribution systems and methods for such software applications.

Conventionally, software applications that allow multiple users to interact, such as applications available through social networks, are often free. Requiring payment for these applications diminishes the number of one's friends who also use the application because of the monetary barrier to entry, and thus diminishes the usefulness and the corresponding incentive to buy for any individual. This situation can also be true for sharing content that users must pay to access. However, to provide an incentive to developers to invest time and resources in creating high quality applications and content, it is desirable to offer a means to compensate the developers for their efforts.

### SUMMARY

To encourage purchases and use, licenses to certain interactive applications and/or content, referred to herein collectively as licensable content, are able to be given as gifts or otherwise redistributed to others as part of a user purchasing a license for herself. In one implementation, each purchase of a license to a piece of licensable content includes the right to give a sublicense to up to a predefined limit of other people. For example, the purchasing user buys a license for herself and the right to distribute sublicenses to a number of other people to the same licensable content. In another embodiment, a purchasing user buys a license to use the licensable content herself separately from buying a license to redistribute the licensable content to others. In another embodiment, each purchase of a license includes the right to give a sublicense for a predetermined time limit. In another embodiment, each purchase of a license to licensable content includes the right to give a sublicense to a number users having a particular characteristic, including but not limited to having a certain type or length of relationship or connection with the purchasing user. As a result, in some embodiments, the first licensed user and the sublicensed users can interact with each other through the licensed interactive application or content.

### BRIEF DESCRIPTION OF THE DRAWINGS

FIG. 1 is a high-level block diagram of the computing environment in accordance with an embodiment of the invention.

FIG. 2 is a high-level block diagram of the relationships between the users with respect to a licensed application, in accordance with an embodiment of the invention.

FIG. 3 is a block diagram of components of the social network provider, in accordance with an embodiment of the invention.

FIG. 4 is a flow chart illustrating a method of licensing an application, in accordance with an embodiment of the invention.

FIG. 5 is a flow chart illustrating a method of licensing content, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the present invention provide systems, methods, and computer-readable storage media for distributing and tracking licenses and sublicenses to interactive applications or content, for example, in the context of a social network environment. As used herein, the term “license” may include a right to use, a covenant not to sue, or other rights or privileges relevant to the interactive applications or content. According to embodiments of the invention, a user who purchases a license also receives the right to distribute a predefined limit of sublicenses to other users for the same licensable content that the users may access, for example, through the social network environment. In another embodiment, the initial purchase of the license is decoupled from the purchase of a license to redistribute the licensable content to others.

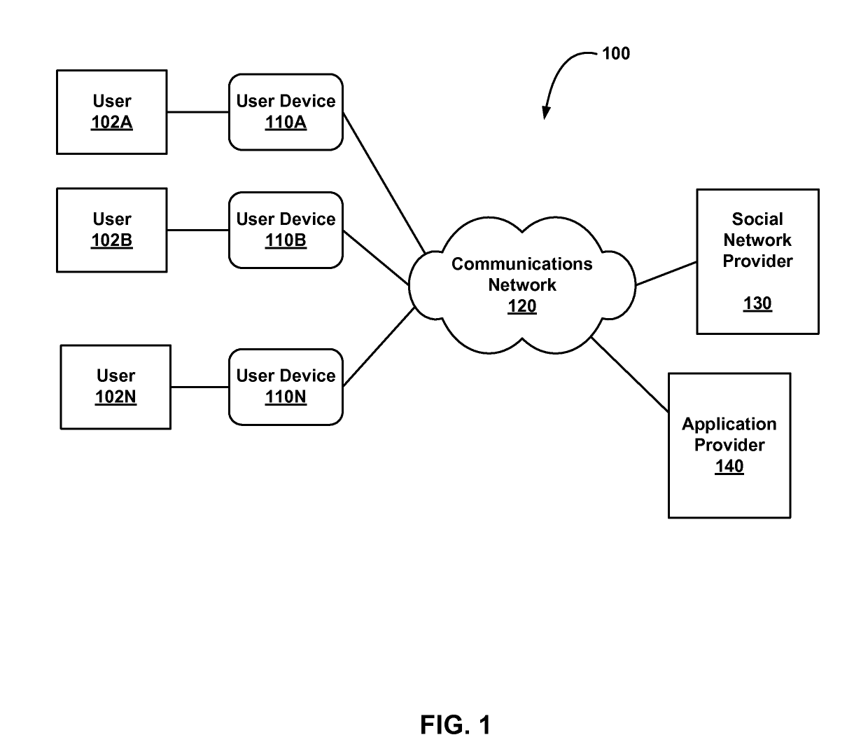

FIG. 1 is an illustration of a computing environment 100 in accordance with one embodiment of the invention. The computing environment 100 includes a plurality of users 102A-N at user devices 110A-N, that are coupled to a social network provider 130 via a communications network 120. In various embodiments, user devices 110 may include a computer terminal, a personal digital assistant (PDA), a wireless telephone, or various other user devices capable of connecting to the network 120. In various embodiments, the communications network 120 is a local area network (LAN), a wide area network (WAN), a wireless network, an intranet, or the Internet, for example.

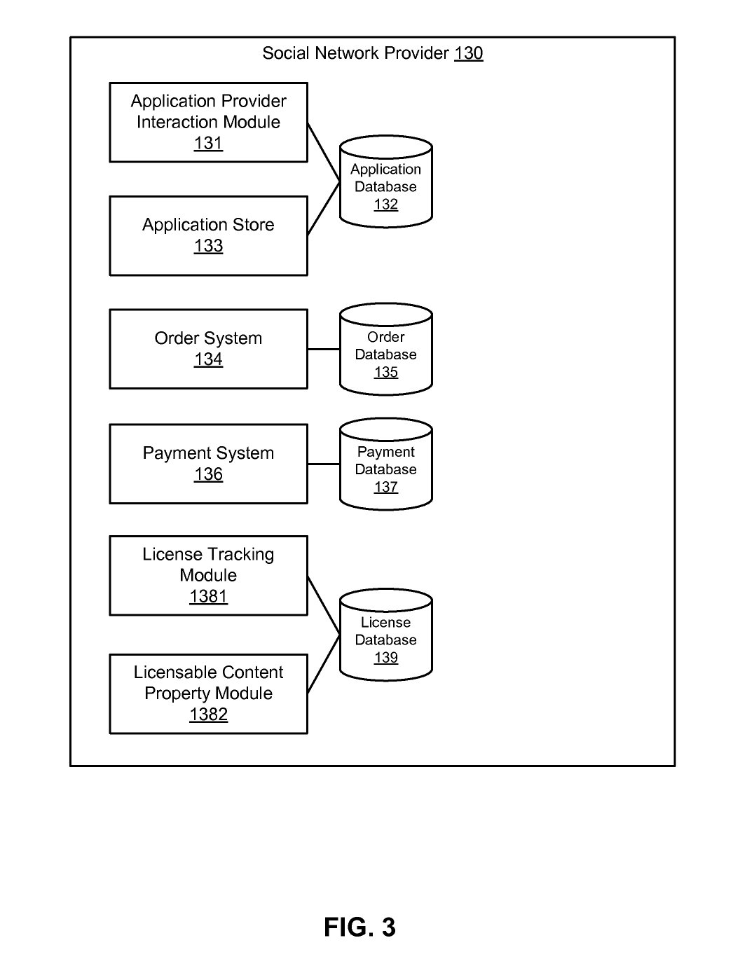

Each user 102A-N is represented by a profile in the social network environment 100 as maintained by the social network provider 130. A user 102A-N may be a person or another entity, such as an organization, that maintains a profile in the social network environment. The profile may occupy an entire web page or a portion of a web page in the social network environment 100. The profile may include various fields relating the user 102, such as contact information, user identification, short news clips relating to the user, social information such as the user's friends, connections, and/or fans and status, a list of photo albums, links, posts, notes, and/or various other content posted by the user. In one embodiment, included in the social information in the profile are relationship details that characterize the relationships that a user has with other users, such as type of relationship, length of relationship, history of communications between the parties, and the like. The relationship details may optionally be displayed in the profile or maintained in association with the profile by the social network provider 130 without being displayed. The user profile may also optionally display and/or provide links to the applications and content, such as games, electronic books, photos, video or audio segments, or any other type of media which the user has licensed. In some cases, these interactive applications and content require a user to have a license to access them. Whether the user purchased the license or who gave the license to the user may optionally be displayed in the profile or maintained in association with the profile by the social network provider 130 without being displayed. In one embodiment, a user is able to access an application store from the user's profile web page. The application store and the social network provider 130 will be described in more detail with reference to FIG. 3.

The computing environment 100 also includes at least one application provider 140 that is coupled to the social network provider 130 via the communications network 140. In one embodiment, the application provider 140 provides interactive applications or content to the social network provider 130 for the social network provider 130 to sell to users 102A-N. The users 102A-N may access the licensable content through a link on a webpage in the social network environment or through a widget or badge displayed on a webpage in the social network environment. The application provider 140 may set the price, the subscription terms including the type of subscription and the length of time, and/or any other distribution terms for the provided licensable content, including how many users or what type of users can be sublicensed by a user who purchases a license to the licensable content. The number of users that can be sublicensed must be at least one. The application provider 140 communicates these terms associated with the interactive application to the social network provider 130. In other embodiments, the application provider 140 may be the same entity as the social network provider 130. In this situation, the social network provider 130 sets the price, license and sublicense terms for the distribution of the interactive application or content.

Various embodiments and features of social networks that provide a platform for applications (including third-party applications and applications offered by the social network) that allow interactivity among members of the social network are described in the following patent applications, each of which is incorporated by reference in its entirety: U.S. application Ser. No. 11/893,559, filed Aug. 15, 2007; U.S. application Ser. No. 12/194,511, filed Aug. 19, 2008; U.S. application Ser. No. 12/253,149, filed Oct. 16, 2008; U.S. application Ser. No. 12/138,212, filed Jun. 12, 2008; and U.S. application Ser. No. 12/154,504, filed Feb. 23, 2008.

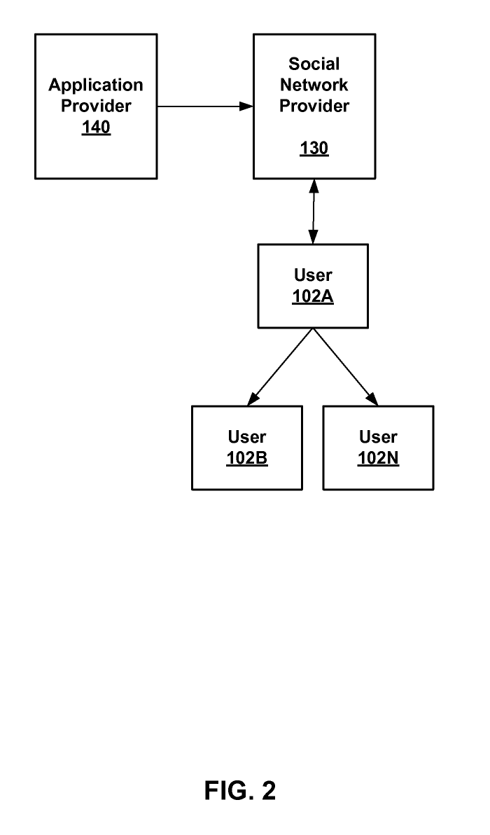

FIG. 2 is a high-level block diagram of the relationships between the users with respect to a licensed application, in accordance with an embodiment of the invention. As shown in the example of FIG. 2, the application provider 140 provides an interactive application or content to the social network provider 130. The social network provider 130 sells a license to the application to a first user 102A. In one embodiment, the user may be located on the social network when purchasing the application or content. In another embodiment, the user may be located off the social network, but in communication with the social network via a widget, desktop application, or badge, etc. In the example where the social network provider sells a license to the application to a first user, the license to the first user 102A includes the right to sublicense two additional users. The first user 102A then sublicenses the application to users 102B and 102N. Again, it should be noted that sublicenses can be distributed to any given number of users up to the limit purchased by the first user 102A.

In some embodiments, the rights to use the interactive application or content purchased by the first user 102A is the same as the rights given to users 102B and 102N, with the exception of the right to give sublicenses which is reserved for users who purchase a license. Meaning, users 102B and 102N cannot distribute sublicenses to other users without purchasing that ability from the application provider. In other embodiments, the rights to use the licensable content purchased by the first user 102A is different from rights given to users 102B and 102N by the first user 102A. For example, the first user 102A who buys a license may have the right to initiate or manage a game through a licensed interactive application, whereas the rights given to users 102B and 102N are solely to play in a game that has already been initiated and/or managed by a user 102A who has bought a license. As another example, the first user 102A who buys a license may have full access rights to expansions to the game, whereas the rights given to users 102B and 102N are solely to a more basic version of the game. As another example, the first user 102A who buys a license may have access rights to read, add to, and edit aspects of interactive content, whereas the rights given to users 102B and 102N are solely to read and add to the interactive content, without the right to edit aspects of the interactive content.

FIG. 3 is a block diagram of components of the social network provider 130, in accordance with an embodiment of the invention. The social network provider 130 includes an application provider interaction module 131, an application store 133, an application database 132, an order system 134, an order database 135, a payment system 136, a payment database 137, a license tracking module 1381, a licensable content property module 1382, and a license database 139.

The application provider interaction module 131 receives an interactive application or content provided by application providers 140 or information identifying the interactive application or content, along with terms for the sale of a license to the interactive application or content, including at least price for the license and number of sublicenses that can be given to others. The application provider interaction module 131 may also inform the application provider 140 of a revenue share from the sale of licenses to the interactive application. The application provider interaction module 131 stores the received application or content, information identifying the interactive application or content, and the terms for the sale of a license in the application database 132. In some embodiments, the price depends on the number of sublicenses that can be given to others as part of the purchase. For example, the application may cost $2.00 for a license that comes with rights to sublicense 2 others, and $3.00 for a license that comes with rights to sublicense 5 others. Thus, several options of pairings of price and number of sublicenses can be stored in the database 132. In another embodiment, the price of a license and its sublicense may depend on whether the user has elected to allow advertisements to be displayed along with the application or content. For example, the price to purchase a license to use and two sublicenses to distribute a simple game application that includes advertisements shown in a banner during game play may be $3, whereas the price to purchase a license to use and two sublicenses to distribute the same simple game application that does not display advertisements during game play may be $6. In another embodiment, the purchase price and/or the number of sublicenses that are purchased for that price depends on the purchasing user's history of distributing sublicenses. For example, if the user has purchased many licenses and has frequently distributed sublicenses to others, the purchase price for a new license may decrease for that user, and/or the number of sublicenses to distribute to others may increase. In another embodiment, the purchase price and/or the number of sublicenses that are purchased for a given price fluctuates over time. For example, an application may be free and come with 5 free sublicenses to the first 100 users to take advantage of the offer, but the price may rise to $1 with 5 sublicenses after the first 100 users have taken advantage of the offer. The price may rise or fall over time. The number of sublicenses available for the price may rise or fall over time. The price and the number of sublicenses may move in the same or opposite directions. Any combination of these trends may be established by the entity identifying the terms of sale, as described above.

As shown in FIG. 3, the application database 132 is a storage location internal to the social network provider 130. Alternatively, the application database 132 may reside at any location communicatively coupled to the social network provider 130.

The application store 133 offers interactive application or content for sale to users 102A-N. The users 102A-N may access the application store 133 through a user interface of the social network provider 130. In another embodiment, the users 102A-N may access the application store through a user interface associated with, but located off, the social network such as a widget, desktop application, or badge. The application store 133 presents for sale the interactive applications and content stored or described in the application database 132. The application store 133 also displays to the user 102A the terms for the sale of a license to the interactive application or content, including at least the price, which may be zero for some users, for the license and number of sublicenses that can be given to others. If applicable, the options of pairings of price and number of sublicenses are also displayed.

The order system 134 receives order information from the application store 133 when a user initiates a purchase through the application store 133. The order system 134 responds by creating a record in the order database 322 to record the order details, including the price and quantity of sublicenses that are purchased. The order system 134 may invite the user 102A to confirm the purchase of the interactive application or content. When the user 102A confirms the purchase, the order system 134 sends an authorization to charge the purchase amount to the payment system 136.

The payment system 136 manages the payment from the user 102A for the interactive application or content that the user 102A has purchased. Although the payment system 136 is shown in FIG. 3 as internal to the social network provider 130, in another embodiment, the payment system 136 is external to the social network provider 130 and communicatively coupled to the social network provider 132 directly or through the communications network 120. The payment system 136 receives the authorization to charge the purchase amount from the order system 134. The payment system 136 creates a transaction record in the payment database 137. The payment amount (i.e., the purchase price in money or virtual currency or a combination of money and virtual currency) is then debited from the user's account and recorded in the payment database 137. The payment system 136 confirms when the payment authorization is complete to the order system 134. In the situation that the application provider 140 stores the interactive application or content that has been purchased, the order system 134 directs the application provider 140 to deliver the purchased application or content to the user 102A along with the right to distribute the given number of sublicenses. When the application provider 140 confirms the purchased application or content has been delivered via the application provider interaction module 131, the payment system 136 credits a portion of the revenue from the sale to an account associated with the third party application provider 140 in the payment database 137.

Once the application provider 140 confirms that the purchased application or content has been delivered to the user 102A, the order system 134 notifies the license tracking module 1381 of the licensed user 102A and the number of sublicenses that the licensed user 102A may distribute along with any time limits on the term of the license or sublicenses for tracking purposes. The license tracking module 1381 stores information about all users that have licensed an interactive application or content and the status of the sublicenses associated with the licensed users in license database 139. The license database 139 may include tables that identify which users have access rights to which applications, and whether those access rights resulted from the user purchasing the rights or being given the rights by another user and the identity of the other user. The license database 139 may be used to update the information about licensed applications and content stored in the user profiles. In one embodiment, the license database 139 also includes the status of the sublicenses, including the number and identity of users that a licensed user 102A has offered a sublicense and information tracking whether the users who have been offered a sublicense have accepted the offer, rejected the offer, or are still considering the offer. In one embodiment, a licensed user 102A may only offer a sublicense to another user if the number of offers that the user 102A has made is less than the total number of sublicenses associated with the user's purchase of the license. If an offer of a sublicense is rejected, it is no longer counted in the number of offers that the user 102A has made. Thus, the user 102A may offer the rejected license to another user. In one embodiment, the license tracking module 1381 tracks whether a user already has a license or sublicense to an interactive application or content, and either a user 102A is prevented from offering a sublicense to the already-licensed or sublicensed user, or the offer to sublicense the already-licensed or sublicensed user is not counted against the number of sublicenses a licensed user can give away.

In another embodiment, the terms of the sublicenses allows the user 102A to license up to N number of users who meet a particular characteristic, such as having a pre-established relationship or a relationship of a certain length with the user 102A, where N is the number of sublicenses that the user 102A purchased. Thus, the user 102A can inform his friends that the first N friends that claim one of the N sublicenses can access the application. In this embodiment, the license tracking module 1381 tracks the users that attempt to access the application and matches them against the list of the user's friends stored in association with the user's profile. The tracking module 1381 stores the identities of the first N users that attempt to access the application and assigns one of the user's sublicenses to each of them. When all the sublicenses have been allocated, any additional users that attempt to access the application are prevented from gaining access without paying the license fee. In various other embodiments, any set of characteristics used to define a pool of users eligible to claim a sublicense purchased by the user 102A may be established by the application provider 140 or the user 102A. Other examples of characteristics include type of relationship with the user, length of relationship with the user, members of a sub-network, members of an interest group, or any other characteristic stored in association with user profiles.

The licensable content property module 1382 maintains the licensing rights of the licensable content as specified by the content owner. The terms of licenses can be received through the application provider interaction module 131 from the application providers, such as price per license, number of licenses to share on purchase of a license, the validity time-frame of a license, and/or other terms, conditions, or policies of the license. The licensable content property module 1382 can also manage policies which can change the terms and conditions of the license based on factors including but not limited to time, number of licenses sold, popularity rating of the licensed content, and performance of other content. For example, the licensable content property module 1382 can change the purchase price and/or the number of sublicenses that are purchased for that price depending on the purchasing user's history of distributing sublicenses, as described above.

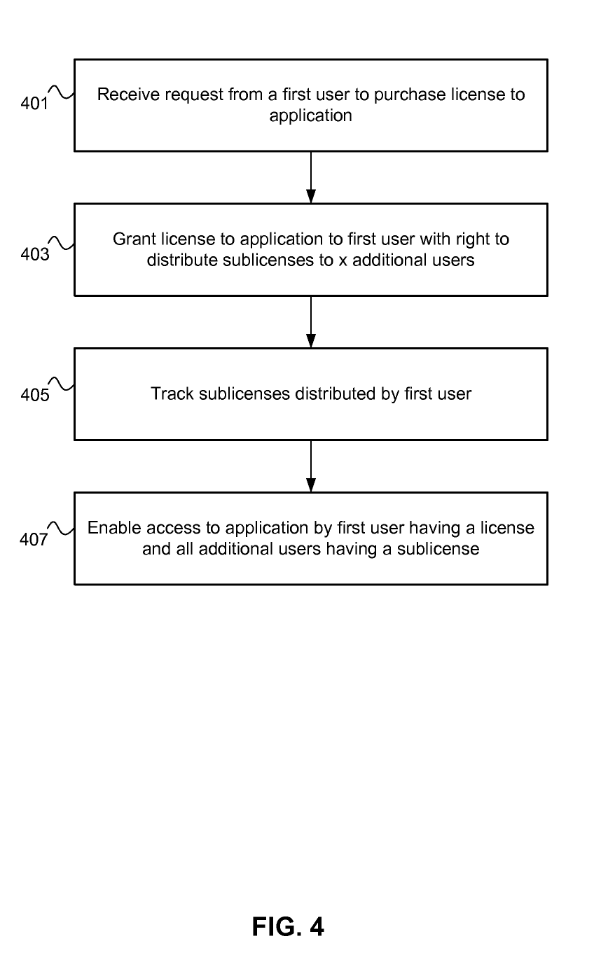

FIG. 4 is a flow chart illustrating a method of licensing applications, in accordance with an embodiment of the invention. In step 401, a request is received from a first user to purchase a license to an interactive application or content. For example, a user may be interested in licensing an interactive game to play with his friends in the social network for a period of time. The request may be received as a purchase order from the first user though the application store 133 of the social network provider 130.

In step 403, a license to the application is granted to the requesting user along with the right to distribute sublicenses to a number of additional users in accordance with the terms of purchased licenses and sublicenses, including any limits on the period of time. In one implementation, the purchase price of a license to an interactive application or content comes with the right to distribute 10 sublicenses to the same interactive application or content to give to other users, such as other members of the user's social network. Thus, in this example, the first user is notified that he may distribute 10 sublicenses to his friends with whom he wants to play the interactive game for which he has purchased the license.

In step 405, the sublicenses distributed by the first user are tracked. As described above, a license tracking module 1381 of the social network provider 130 stores information about users that have licensed an interactive application or content and the status of the sublicenses associated with the licensed users in a license database 139. The license tracking module 1381 of the social network provider 130 receives a notice that the user 102A has distributed a sublicense. In this example, as the first user offers sublicenses to the interactive game to his friends, the license tracking module 1381 tracks the number of offers that the first user has made and optionally the identity of his friends to which the offers were made along with whether they accept, reject, or are still considering the offer. In this way, the license tracking module 1381 can manage the access rights of the sublicensed users to the licensable content. In one implementation, the license tracking module 1381 can also enforce the limit to the number of sublicenses that the first user can offer according to the purchase agreement. In one embodiment, a licensed user 102A may only offer a sublicense to another user if the number of offers that the user 102A has made is less than the total number of sublicenses associated with the user's purchase of the license. If an offer of a sublicense is rejected, it is no longer counted in the number of offers that the user 102A has made. Thus, the user 102A may offer the rejected license to another user.

In step 407, the first user and all additional users having a sublicense from the first user are enabled to access to the licensable content. In one embodiment, the application provider 140 consults the license database 139 and/or the information stored in connection with the user profile to determine whether a user is allowed to access the interactive application or content. Thus, the first user can play the licensed game with the friends to whom he distributed the sublicenses.

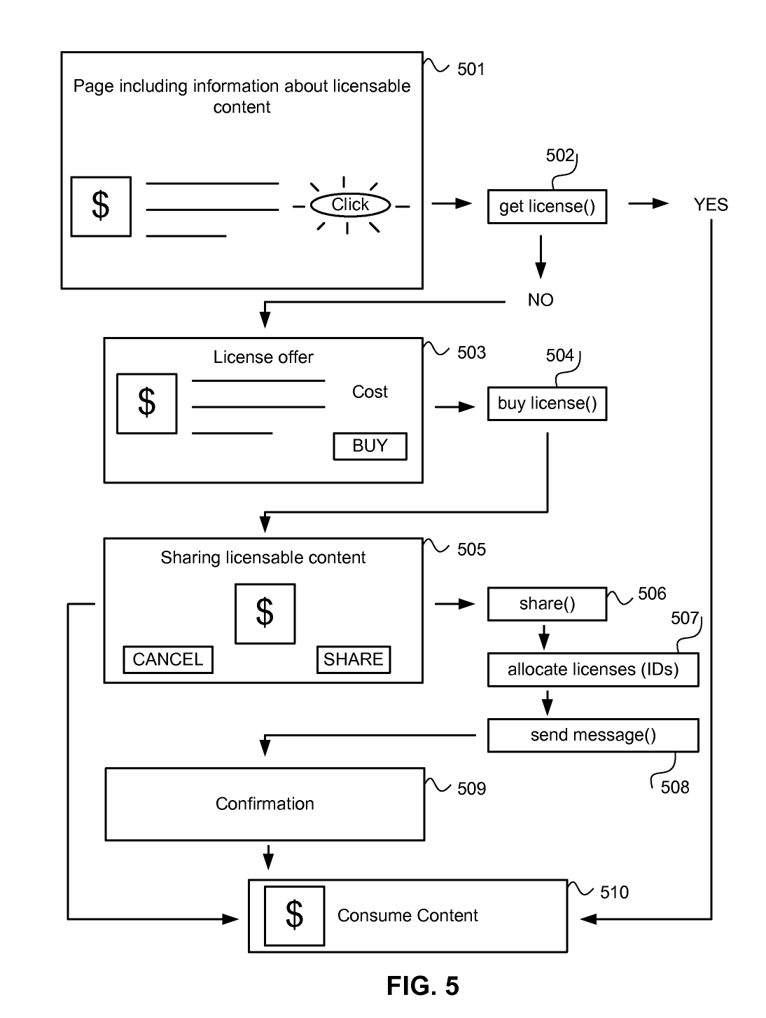

FIG. 5 is a flow chart illustrating a method of licensing content, in accordance with an embodiment of the invention. In step 501, a page including information about licensable content is displayed to a first user. The page may be a user profile page, for example, of another user who licensed the content, or can be any other page containing an advertisement for the licensable content or information about the licensable content. If the first user selects the licensable content, for example by clicking on it, in step 502, a get license( ) function executes that attempts to access the licensable content for the first user. The get license( ) function, through the license tracking module 1381 accesses license database 139 to determine if the first user has access rights to the licensable content. If yes, the method proceeds to allow the first user to consume the content 510. If the first user does not have access rights to the licensable content, a license offer 503 is displayed to the first user. The license offer 503 can include a description of the licensable content, the cost of the license, the time period of the license, the number of sublicenses available to share with others, and any other relevant terms for the license.

If the first user elects to buy the licensable content, a buy license( ) function 504 executes. The buy license( ) function 504 can include the exchange of the first user's money or virtual currency as payment in exchange for the license. The buy license( ) function updates the license tracking module 1381 to indicate that the first user has purchased the licensable content.

Next, the first user is presented with an interface for sharing licensable content 505. The first user can elect to share the predetermined number of sublicenses with other users. If the user chooses to forego sharing the sublicenses at this point in time, the first user can proceed to consuming the content 510. If the first user chooses to share the content, a share( ) function 506 operates to allow the first user specify additional users, for example, from among the first user's friends or fans to which to distribute sublicenses. Then, the allocate licenses (IDs) function 507 updates the license tracking module 1381 to indicate that the identified additional users are licensed to consume the licensable content through the first user's original purchase. A send message ( ) function 508 informs the identified additional users that they are newly licensed to consume the licensable content, for example, by sending the identified additional users an email message. The message sent optionally identifies the first user who licensed the licensable content through which the identified additional users can now share in consuming the content.

In step 509, a confirmation is provided to the first user that the identified additional users have been notified of the first user's sharing of the consumable content. Then the first user can proceed to consume the content 510.

The present invention has been described in particular detail with respect to several possible embodiments. Those of skill in the art will appreciate that the invention may be practiced in other embodiments. For example, embodiments of the invention have been described in the context of a social network environment. However, it is appreciated that embodiments of the invention may also be practiced in other communications network environments that include components to enable the purchasing of interactive applications and content, and the tracking of licenses and sublicenses as described above. For example, outside the context of the social network provider, any payment provider and/or application developer can manage a system wherein a first user who purchases a use license can also purchase a license to redistribute the application to others or to grant sublicenses to the application. In such circumstances, the payment provider and/or application developer tracks the sublicenses distributed by the first user and allows access to the application by the first user having the license and all additional users having a sublicense.

The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of distributing access rights to a licensable interactive application, the method comprising:
receiving a request from a first user to purchase at least one sublicense to a licensable interactive application;
responsive to the request, granting the at least one sublicense to the first user to distribute; and
providing access to the licensable interactive application to the at least one sublicensed user, thereby enabling the first user to interact with the at least one sublicensed user through the interactive application.

2. The method of claim 1, wherein the purchase of the at least one sublicense by the first user is coupled to a request by the first user to purchase a license to the licensable interactive application

3. The method of claim 1, wherein the first user has obtained a license to the licensable interactive application.

4. The method of claim 3, wherein the at least one sublicense has a different set of rights to the licensable interactive application as compared to the license obtained by the first user.

5. The method of claim 1, further comprising receiving payment from the first user at least partially in the form of virtual currency.

6. The method of claim 1, further comprising storing a set of pairings of number of sublicenses and purchase price.

7. The method of claim 6, wherein at least one pairing of a number of sublicenses and a purchase price depends on whether advertisements are allowed to be displayed along with the licensable interactive application.

8. The method of claim 6, wherein at least one pairing of a number of sublicenses and a purchase price changes over time.

9. The method of claim 6, wherein at least one pairing of a number of sublicenses and a purchase price changes after a threshold number of users is reached.

10. The method of claim 1, wherein the first user and the at least one sublicensed user are members of a social network.

11. The method of claim 10, wherein the first user has connections to other members of the social network, and wherein granting the at least one sublicense to the first user comprises granting the at least one sublicense to the first user to distribute to at least one member of the social network to whom the first user is connected.

12. The method of claim 1, wherein the at least one sublicense is time-limited.

13. The method of claim 1, wherein the licensable interactive application comprises an interactive game application.

14. The method of claim 1, further comprising tracking the at least one sublicense distributed by the first user.

15. The method of claim 14, wherein tracking the at least one sublicense comprises receiving a notification that the first user has distributed a sublicense to another user.

16. The method of claim 14, wherein tracking the at least one sublicense distributed by the first user comprises receiving a selection of a characteristic, the characteristic defining a pool of users who are eligible to claim a sublicense distributed by the first user, and wherein providing access to the at least one sublicensed user comprises verifying that the sublicensed user has the selected characteristic before enabling access to the interactive application.

17. The method of claim 16, wherein the selected characteristic defines the pool of users who are eligible to claim a sublicense distributed by the first user to be the first user's friends within a social network, and wherein allowing access to the at least one sublicensed user comprises verifying that the sublicensed user is the first user's friend within the social network.

18. The method of claim 1, further comprising:
tracking a history, of the first user, of distributing sublicenses to licensable interactive applications purchased by the first user;
determining a purchase price for at least one item of licensable content based in part on the first user's history.

19. A method of distributing an interactive game, the method comprising:
receiving a purchase request from a first user for an interactive game;
responsive to the purchase request, licensing a first user to play the interactive game and distribute at least one sublicense to at least one other user to play the interactive game; and
providing the first user and the at least one sublicensed user access to play the interactive game with each other.

20. A system for distributing access rights to a licensable interactive application, the system comprising:
an order system for receiving a request from a first user to purchase at least one sublicense to a licensable interactive application; and
a license tracking module for:
responsive to the request, granting the at least one sublicense to the first user to distribute; and
providing access to the licensable interactive application to the at least one sublicensed user, thereby enabling the first user to interact with the at least one sublicensed user through the interactive application.

21. The system of claim 20, wherein the purchase of the at least one sublicense by the first user is coupled to a request by the first user to purchase a license to the licensable interactive application.

22. The system of claim 20, wherein the first user has obtained a license to the licensable interactive application.

23. The system of claim 22, wherein the at least one sublicense has a different set of rights to the licensable interactive application as compared to the license obtained by the first user.

24. The system of claim 20, further comprising a payment system that receives payment from the first user at least partially in the form of virtual currency.

25. The system of claim 20, further comprising an application database that stores a set of pairings of number of sublicenses and purchase price.

26. The system of claim 25, wherein at least one pairing of a number of sublicenses and a purchase price depends on whether advertisements are allowed to be displayed along with the licensable interactive application.

27. The system of claim 25, wherein at least one pairing of a number of sublicenses and a purchase price changes over time.

28. The system of claim 25, wherein at least one pairing of a number of sublicenses and a purchase price changes after a threshold number of users is reached.

29. The system of claim 20, where the first user and the at least one sublicensed user are members of a social network.

30. The system of claim 29, wherein the first user has connections to other members of the social network, and wherein granting the at least one sublicense to the first user comprises granting the at least one sublicense to the first user to distribute to at least one member of the social network to whom the first user is connected.

31. The system of claim 20, wherein the at least one sublicense is time-limited.

32. The system of claim 20, wherein the licensable interactive application comprises an interactive game application.

33. The system of claim 20, wherein the license tracking module is further for tracking the at least one sublicense distributed by the first user.

34. The system of claim 33, wherein tracking the at least one sublicense comprises receiving a notification that the first user has distributed a sublicense to another user.

35. The system of claim 33, wherein tracking the at least one sublicense distributed by the first user comprises receiving a selection of a characteristic, the characteristic defining a pool of users who are eligible to claim a sublicense distributed by the first user, and wherein enabling access to the at least one sublicensed user comprises verifying that the sublicensed user has the selected characteristic before enabling access to the interactive application.

36. The system of claim 35, wherein the selected characteristic defines the pool of users who are eligible to claim a sublicense distributed by the first user to be the first user's friends within a social network, and wherein allowing access to the at least one sublicensed user comprises verifying that the sublicensed user is the first user's friend within the social network.

37. The system of claim 20, wherein the license tracking module is further for tracking a history, of the first user, of distributing sublicenses to licensable content purchased by the first user, and the system further comprises a licensable content property module for determining a purchase price for at least one item of licensable content based in part on the first user's history.

38. A system for distributing an interactive game, the system comprising:
an order system for receiving a purchase request from a first user for an interactive game;
a license tracking module for:
responsive to the purchase request, licensing a first user to play the interactive game and distribute at least one sublicense to at least one other user to play the interactive game; and
providing the first user and the at least one sublicensed user access to play the interactive game with each other.
